(19) United States
(12) Patent Application Publication
(10) Pub. No.: US 2016/0318025 A1
(43) Pub. Date: Nov. 3, 2016

(54) SIDE WEAR PROTECTION FOR THE ROLLER OF A ROLLER PRESS

(71) Applicant: TAKRAF GmbH, Leipzig (DE)

(72) Inventors: Meinhard FRANGENBERG, Kürten-Engeldorf (DE); Jörg SCHNEPPER, Köln (DE)

(73) Assignee: TAKRAF GmbH, Leipzig (DE)

(21) Appl. No.: 15/142,874

(22) Filed: Apr. 29, 2016

(30) Foreign Application Priority Data
Apr. 29, 2015 (DE) 10 2015 207 927.9

(51) Int. Cl. B02C 4/30

(52) U.S. Cl. CPC B02C 4/305; B02C 2210/02

(57) ABSTRACT

The present invention relates to side wear protection for rollers of a roller press and to a roller of a roller press comprising this side wear protection. In one embodiment, the side wear protection according to the present invention and for the roller of a roller press comprises several side wear protection element surrounding the roller edge. According to the present invention, the side wear protection elements have a base body comprising an elastic, ductile material. Furthermore, the base body has a threaded bolt on the side of the base body directed toward the roller axis.

### CROSS-REFERENCE TO RELATED APPLICATIONS

This application claims priority benefit under 35 U.S.C. §119 of German Patent Application No. 10 2015 207 927.9, filed Apr. 29, 2015, the entire contents of which are incorporated herein by reference.

### FIELD OF THE INVENTION

The present invention relates to the side wear protection for rollers of a roller press and to a roller of a roller press comprising this side wear protection.

### BACKGROUND OF THE INVENTION

Roller presses, also called high-pressure grinding rolls, comprise two rollers with the same diameter between which the material to be comminuted is introduced and forms a material bed there. A compacting takes place by the opposite rotation of the rollers and the high pressure on the material between the rollers.

The surfaces of the rollers are exposed to a high wear. For this reason protective wear layers are used on the roller surface. For example, EP 0443 195 A1 suggests applying nubs of hard metal by welding on the roller surface. Another solution shown in DE 10 2010 924 221 consists in applying a bandage on the roller of a roller press consisting of an iron alloy with a high chromium content. The bandage is constructed in a profiled manner on the outside to improve the wear protection. Lastly, among others it is known to introduce cylinder bodies into the surface of the roller from DE 4132 474 A1, among others.

The lateral closure of the wear protection seems problematic. The radial pressure forces as well as axial forces must be received there. The wear protection should also comprise the outer areas of the front sides of the rollers since laterally exiting material leads to wear there.

EP 1 684 907 B1 suggests forming a front surface steel shielding in the area of the rotating cylinder edge consisting of a plurality of prefabricated hard bodies arranged adjacent to each other in a circle. The hard bodies are preferably shaped like a hammerhead and fastened, in particular adhered in radial grooves. This front surface steel shielding has the disadvantage that the hard bodies can break. In addition, the fastening by adhesion or soldering cannot be readily separated and therefore a repair of the roller is not possible or is possible only with great difficulty. Last but not least, the great manufacturing tolerances in structural components like hard metal result in large adhesive gaps or in significant problems in the assembly when the hard bodies have an oversize. The large adhesive gaps are problematic since no reliable adhesion is possible and the hard bodies can fall out of the roller surface during operation. In addition, a large amount of adhesive must be used, which is disadvantageous for the large adhesive slot.

Also, a special adhesive is required, which is disadvantageous for the adhesion of large adhesive gaps. Excessively large hard bodies result, in addition to the problems during assembly and the associated expenses, in the risk that during the assembly fissures are produced in the hard metal bodies which can result in a subsequent failure. Last but not least, the use of hard metal entails very high expenses.

The present invention is directed to addressing these and other deficiencies in the art.

### SUMMARY OF THE INVENTION

The present invention relates to the side wear protection for rollers of a roller press and to a roller of a roller press comprising this side wear protection.

As set forth herein, numerals associated with various aspects of the present invention are as described in Table 1 herein.

In one aspect, the present invention provides a roller (4) of a roller press comprising a side wear protection element (1) with a base body (11) of an elastic material with a threaded bolt (13), wherein the threaded bold (13) of the side wear protection element (1) is run through a roller edge (41) of the roller (4).

In one embodiment, the present invention provides a roller (4) of a roller press according to the present invention, characterized in that the base body (11) of the side wear protection element (1) has a parallelepipedic shape or is cylindrical with a round base surface which is preferably flattened on one side.

In one embodiment, the present invention provides a roller (4) of a roller press according to the present invention, characterized in that the side of the base body (11) of the side wear protection element (1) directed toward the steel screen shielding (42) of the roller comprises at least one arch (43), preferably a concave arch and otherwise has a parallelepipedic shape.

In one embodiment, the present invention provides a roller (4) of a roller press according to the present invention, characterized in that the hard bodies (2) are fastened on the sides of the base body (11) which form the jacket surface and the front side of the roller in the assembled state.

In one embodiment, the present invention provides a roller (4) of a roller press according to the present invention, characterized in that an L-shaped hard body is fastened which extends from the jacket surface to the front side of the roller (4) and therefore covers the roller edge.

In one embodiment, the present invention provides a roller (4) of a roller press according to the present invention, characterized in that the hard body or hard bodies (12) consist of hard metal or of a very firm iron alloy (IFW).

In one embodiment, the present invention provides a roller (4) of a roller press according to the present invention, characterized in that the hard bodies (12) are soldered on.

In one embodiment, the present invention provides a roller (4) of a roller press according to the present invention, characterized in that receptacles for tensioning pins (15) or tensioning pins (2) are arranged on the side of the base body (11) directed toward the roller edge (41).

In one embodiment, the present invention provides a roller (4) of a roller press according to the present invention, characterized in that the threaded bolt (13) is stepped and has a distinctly greater diameter starting from the base body (11).

In one embodiment, the present invention provides a roller (4) of a roller press according to the present invention, characterized in that the elastic material is an elastic, ductile steel.

In one embodiment, the present invention provides a roller (4) of a roller press according to the present invention, characterized in that the support of the base body (11) on the roller is a linear support (14) in the axial direction of the roller.

In one embodiment, the present invention provides a roller according to the present invention, characterized in that an intermediate element (3) that can be replaced with different thicknesses is arranged between the side wear protection element (1) and the roller edge (41).

In one embodiment, the present invention provides a roller according to the present invention, characterized in that the threaded bolt (13) of the side wear protection element (1) is run through a roller edge (41) of the roller (4) and is screwed there, wherein the screwing has a pre-tension.

In one embodiment, the present invention provides a roller according to the present invention, characterized in that the base body (1) is axially fixed in the steel screen shielding and can therefore receive transverse forces.

In another aspect, the present invention provides a roller press comprising a roller according to the present invention.

In certain embodiments, the side wear protection according to the invention and for the roller of a roller press consists of several side wear protection element surrounding the roller edge. According to the invention the side wear protection elements have a base body consisting of an elastic, ductile material. Furthermore, the base body has a threaded bolt on the side of the base body directed toward the roller axis.

Hard bodies are preferably fastened on the cover side and on the front side of the base body. The hard bodies are preferably manufactured from hard metal or from a very firm iron alloy (IFW), for example FeCrMoVC.

The volume of the required hard metal can be advantageously significantly reduced by the invention, which is equivalent to a distinct lowering of the expenses. Fitting problems during the incorporation of the hard bodies such as in the prior art are not to be feared. Also, the dismounting of the side wear protection is possible without problems by loosening the screw connection and the previously necessary, expensive heating of the adhesive connection can be eliminated. The holding function of the side wear protection elements is advantageously ensured by the base body consisting of elastic material, which considerably reduces the danger of breakage.

These and other objects, features, and advantages of this invention will become apparent from the following detailed description of the various aspects of the invention taken in conjunction with the accompanying drawings.

### BRIEF DESCRIPTION OF THE DRAWINGS

For the purpose of illustrating aspects of the present invention, there are depicted in the drawings certain embodiments of the invention. However, the invention is not limited to the precise arrangements and instrumentalities of the embodiments depicted in the drawings. Further, if provided, like reference numerals contained in the drawings are meant to identify similar or identical elements.

FIG. 1 is a drawing illustrating different views of a side wear protection element according to one embodiment of the present invention.

FIG. 2 is a drawing illustrating a view of a roller edge with side wear protection elements according to one embodiment of the present invention and in accordance with FIG. 1.

FIG. 3 is a drawing illustrating another view of the roller edge from FIG. 2.

FIG. 4 is a drawing illustrating a side view of the roller edge from FIG. 2.

FIG. 5 is a drawing illustrating two views of an alternative embodiment of a side wear protection element of the present invention.

FIG. 6 is a drawing illustrating a side view of a roller edge with side wear protection elements according to FIG. 5.

FIG. 7 is a drawing illustrating an alternative embodiment of a wear protection element of the present invention.

FIG. 8 is a drawing illustrating a roller with wear protection elements according to FIG. 7.

### DETAILED DESCRIPTION OF THE INVENTION

The present invention is directed to, inter alfa, solving the noted deficiencies in the prior art by providing a side wear protection for the roller of a roller press that has a long service life and makes possible a simple and rapid replacement.

More particularly, in various aspects, the present invention solves the noted problems in the prior art by providing a roller for a roller press comprising a side wear protection as described herein and by a roller press as also described herein.

In certain embodiments, the roller in accordance with the invention for a roller press with a side wear protection comprises several side wear protection elements surrounding the roller edge. According to the invention the side wear protection elements comprise a base body of an elastic, ductile material. Furthermore, the base body comprises a threaded bolt on the base body side directed toward the roller axis.

In the following, in order to simplify the description, a definition of the sides of the base body and of the side wear protection element is presented. In the assembled state the side of the base body projects from that of the threaded bolt and is directed toward the central point of the roller (that is, the contact surface with the roller) is the base side. The side opposite this side, that forms the jacket surface of the roller, is designated as the cover side. The side of the base body which forms the front side in the assembled state is the front side and the side opposite the front side, that is adjacent to the steel screen shielding, is the back side. The remaining sides bordering on the adjacent side wear protection elements are designated as ring sides.

In one embodiment the base body has the shape of a parallelepiped. Alternatively, ring sides (the sides of the base body that border on other side wear protection elements) or also on the steel screen shielding of the roller can be designed in such a manner that a positive locking is formed with the adjacent side wear protection elements and the steel screen shielding.

In an alternative embodiment the base body is cylindrical with a round base surface. This base surface is preferably flattened on one side as a support for fastening the hard bodies.

In another embodiment the side of the base body (the back side) directed toward the steel screen shielding is convexly curved, that is, to the outside and is preferably designed to be semicircular. The steel screen shielding is correspondingly designed to be concave. In this manner the mechanical stability of the side wear protection can be advantageously increased.

In another embodiment hard bodies are fastened on the cover side and on the front side of the base body. The hard bodies are preferably manufactured from hard metal or a very firm iron alloy (IFW), for example FeCrMoVC.

In an alternative embodiment an L-shaped hard body is provided which covers the cover side and the front side of the base body. Therefore, advantageously only one hard body must be fastened on the base body and the roller edge is protected over its entire circumference.

In another embodiment the L-shaped hard body has a base form which is not rotationally symmetric, for example triangular, and the steel screen shielding of the roller comprises support surfaces for the hard body in this area. Therefore, a protection against torsion for the base body and therefore also for the side wear protection element is advantageously ensured.

In another embodiment the base body is surrounded by the steel screen shielding in such a manner that the base body is axially fixed and therefore can advantageously receive transverse forces, in particular in the axial direction away from the roller. For example, the base body can be constructed to be round for this and the receptacle in the steel screen shielding surrounds the round base body by more than 180° C.

The hard bodies are preferably soldered on. Alternatively, there is also the possibility of adhering them on or of introducing them with casting technology. Even connections by pressing, screwing and by other mechanical connections are possible. In addition, thermal or other coatings of the base closure body are also conceivable.

The volume of the required hard metal can be advantageously significantly reduced by the invention, which is equivalent to a distinct lowering of the expenses. Fitting problems during the incorporation of the hard bodies such as in the prior art are not to be feared. Also, the dismounting of the side wear protection is possible without problems by loosening the screw connection and the previously necessary, expensive heating of the adhesive connection can be eliminated. The holding function of the side wear protection elements is advantageously ensured by the base body consisting of elastic material, which considerably reduces the danger of breakage.

Another positive effect is the fact that the bathtub wear, that is, a greater wear that is conditioned by wear in the direction of the roller middle and which leads to a reduced radius is reduced by the lesser use of hard metal in the edge area of the roller. In this manner the required grinding volume for eliminating the bathtub-shaped wear is advantageously reduced.

Tensioning pins are preferably arranged between the side wear protection element and the cylinder edge. The tensioning pins receive axial or also tangential forces. To this end the sides of the side wear protection elements directed towards the roller axis comprise receptacles for the tensioning pins or for the tensioning pins themselves. It is especially preferred to arrange two tensioning pins in the area of the ring sides for each side wear protection element. Axial and also tangential forces acting on the side wear protection can advantageously be received by the tensioning pins. The resilient possibilities of tolerances between the support surfaces conditioned by the construction type are advantageously balanced out.

In an alternative embodiment the threaded bolt is stepped, that is, in the vicinity of the base body threaded bolt has a force receiving area with a distinctly greater diameter. The thickened area of the threaded bolt, which borders on the base body is also designated as a collar. The collar is surrounded in the assembled state by a receiving area of the roller edge, as a result of which the axial and tangential forces are advantageously received. The collar of the threaded bolt and the receiving area of the collar in the roller edge preferably form a fit. The slot dimensions of the side wear protection can advantageously be distinctly reduced by the elastic suspension by threaded bolts.

Elastic, ductile steel types, especially annealing steels, fine-grain construction steels or resilient steels are especially preferred. Alternatively, even other highly refractory, ductile metals, e.g., duraliminum can be used.

Furthermore, the support of the side wear protection element on the roller edge is preferably a linear support in the axial direction of the roller. The linear receiving achieves a statically determined support and can advantageously prevent a tipping of the side wear protection elements.

The seating of a body on two surfaces with different angles to one another is very difficult and complex to produce from the standpoint of manufacturing technology for the case that the body should also be seated over the entire surface on these surfaces. Round geometries are advantageous which then form a linear contact with the standing surfaces there bent in such a manner and are significantly simpler to produce.

The roller of the invention for a roller press comprises at least one previously described side wear protection element.

The threaded bolt of the side wear protection element is guided by the roller edge and is screwed. The screwing of the threaded bolt has a pre-tensioning force in a radial direction in an especially preferred manner.

Furthermore, an intermediate element is preferably arranged between the side wear protection element and the roller edge. The threaded bolt or a tensioning pin is preferably run through the intermediate element or the latter is fixed elsewhere in an axial or tangential direction so that a slipping is prevented. The height (that is, the radius of the roller) of the side wear protection elements can be adjusted by the selection of the thickness of the intermediate elements. An adjustment of wear can preferably take place by the adjustment in height and the subsequent grinding of the side wear protection elements for a wear fit that was necessary according to the prior art can be eliminated. In this manner even the replacement of a single side wear protection element is significantly facilitated in an advantageous manner since its height can be adjusted by the intermediate elements and a grinding of the hard metal body for adapting the height is not necessary. This advantage also occurs when using new sides—wear elements, so that their height can be adapted without grinding by the intermediate elements during assembly.

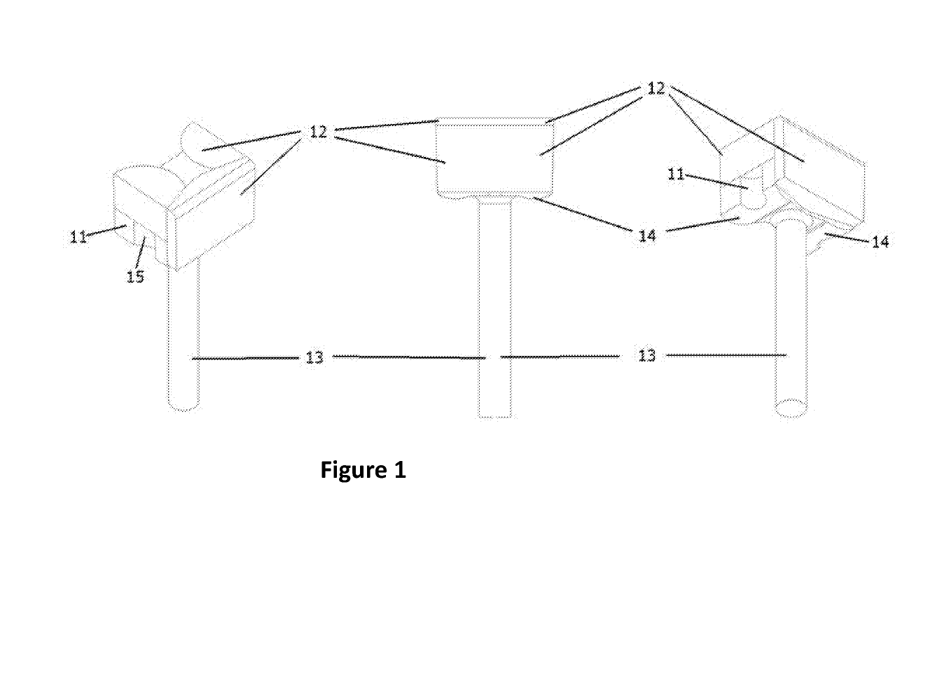

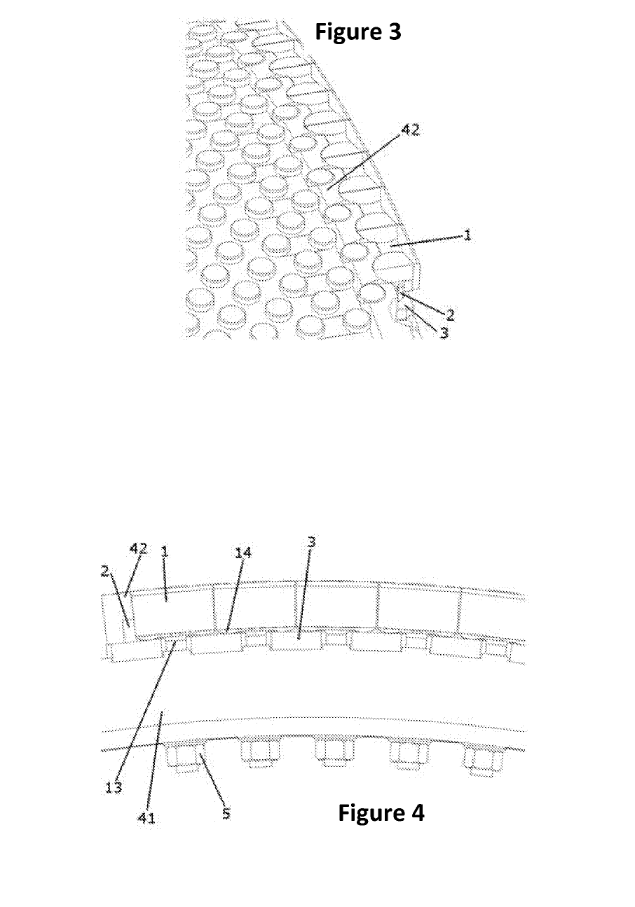

Referring to the drawings, various aspects of the present invention are illustrated in the embodiments shown in FIGS. 1, 2, 3, 4, 5, 6, 7, and 8. In referring to the drawings, various reference numerals are used, as set forth in Table 1 below.

TABLE 1
List of Reference Numerals Used in the Drawings

| Reference Numeral | Description of Element |
|---|---|
| 1 | Side Wear Protection Element |
| 11 | Base Body |
| 12 | Hard Body |
| 13 | Threaded Bolt |
| 14 | Linear Support |
| 15 | Receptacle Tensioning Pin |
| 16 | Grading |
| 2 | Tensioning Pin |
| 3 | Intermediate Element |
| 4 | Roller |
| 41 | Roller Edge |
| 42 | Steel Screen Shielding |
| 43 | Arch |
| 44 | Receptacle Collar/Grading |
| 45 | Receptacle Base Body |
| 46 | Contact Surface |
| 5 | Screwed Nut |

FIG. 1 shows different views of a side wear protection element 1 according to the invention. It comprises a parallelepipedic, elastic base body 11 manufactured from elastically ductile steel. The base body 11 has a threaded bolt 13.

In the assembled state the side of the base body 11, from which the threaded bolt 13 projects, is directed toward the center of the roller, that is, the contact surface with the roller. This side is designated here as the base side. The side opposite this side, which forms the jacket surface of the roller, is designated as the cover side. The side of the base body 11 which side forms the front side of the roller in the assembled state is the front side and the side opposite the front side and which borders on the steel screen shielding of the roller is the back side. The remaining sides, which border on the adjacent side wear protection elements are designated as ring sides.

Hard bodies 12 are soldered on the cover side and front side of the base body 11. The hard bodies 11 consist of hard metal or a very firm iron alloy (IFW). The base side comprises two semicircular recesses 15 in the area of the ring sides which serve as receptacle for tensioning pins 2. The semicircles are arranged in such a manner here that two adjacent side wear protection elements 1 form a circular recess into which a round tensioning pin can be inserted. In addition, the base side comprises two circular linear supports 14 aligned parallel to the ring sides. As a consequence the linear supports 14 are aligned with the two differently inclined planes.

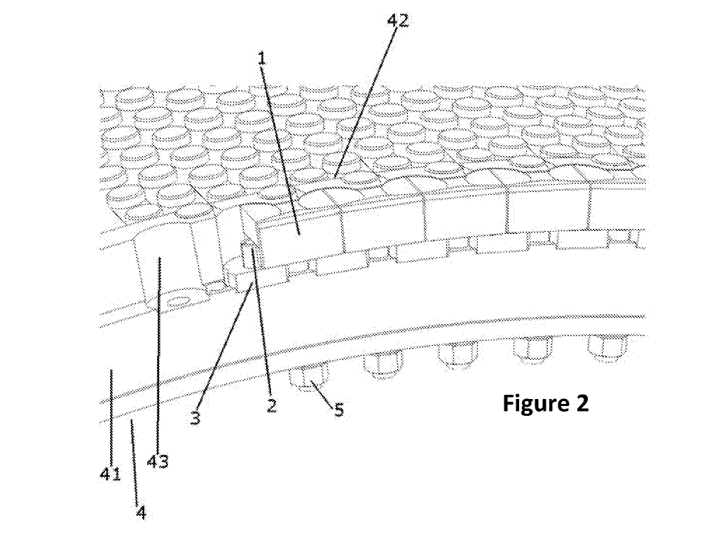

FIGS. 2 to 4 shows a side wear protection elements 1 in the state in which they are incorporated in a roller 4. The threaded bolt 13 is run through the roller edge 41 here and fastened with a screw nut 5. On the back side the side wear protection element 1 borders on the steel screen shielding 42 of the roller 4. The back side of the side wear protection element 1 has a circular arch in the area of each of the ring sides. Therefore, the distance from the front side and the back side in the middle area is smaller than in the area of the ring sides. The side of the steel screen shielding 42 bordering on the side wear protection elements 1 comprises semicircular recesses which receive the circular arches of the side wear protection elements 1. The different bore shapes for receiving the side—closure elements lie in the grid geometry of the steel screen shielding.

In this manner a toothing is formed between the side wear protection elements 1 and the steel screen shielding 42 and avoids groove wear, which offers additional stability for the side wear protection. A replaceable intermediate element 3 is arranged between the base body 11 and the roller edge 41 which element is used for the adjusting of the height (incorporation of different thicknesses for the height adjustment) of the side wear protection elements. The intermediate elements 3 surround the tensioning pins 2 and in addition lie in a recess of the roller edge 41 and are therefore protected against falling out. The tensioning casings 2 are seated in through bores and can therefore be adapted to the different thicknesses of the intermediate elements 3 or optionally be replaced by new ones by driving them in and out.

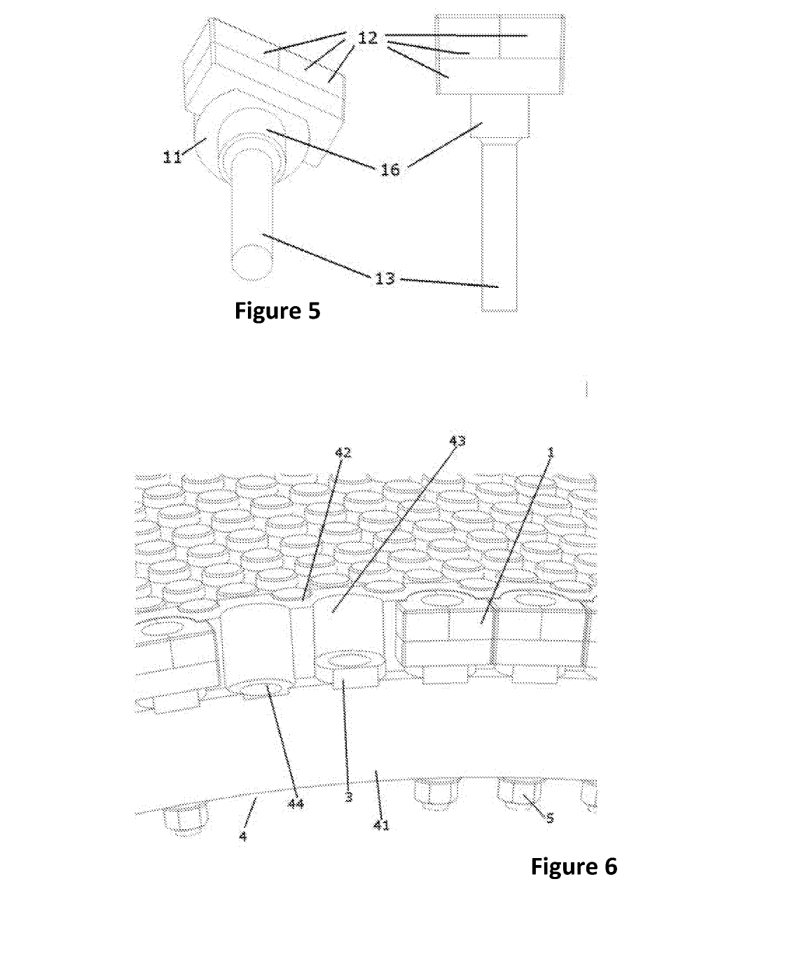

FIGS. 5 and 6 show an alternative embodiment of the side wear protection of the invention. The axial and tangential forces are transferred here via a collar 16 of the threaded bolt 13. The base body 11 is cylindrically constructed and therefore has simple geometries (helical shape) which can be manufactured in a simple manner. The receptacle for the collar 44 is a cylindrical receptacle with a level support surface lying at a right angle to the helical axis.

The bore in the roller edge 41 for receiving the threaded bolt 13 has a corresponding receptacle 44 for the collar 16. The arch of the back side of the side wear protection element 1 is located in the middle in this embodiment relative to the back side. The intermediate element 3 surrounds the threaded bolt 13 here and is therefore secured in its position.

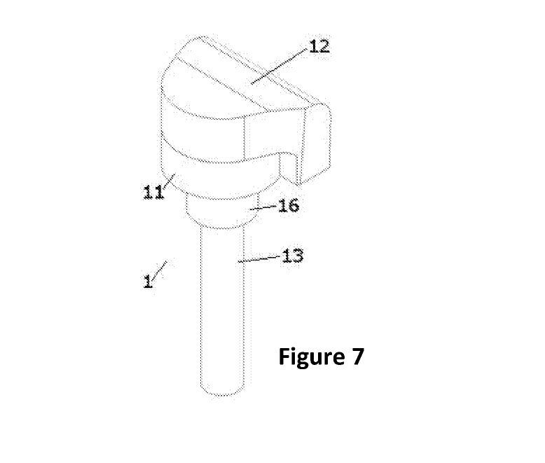

FIG. 7 shows an alternative embodiment of a side wear protection element 1. The latter comprises a one-part hard body 12. The latter is constructed in an L shape and forms the cover side and the front side of the side wear protection element 1. The elastic base body 11 is cylindrical with a circular base surface, wherein the front side of the base body 11 is constructed to be flattened and therefore forms a support for the fastening of the hard body 12.

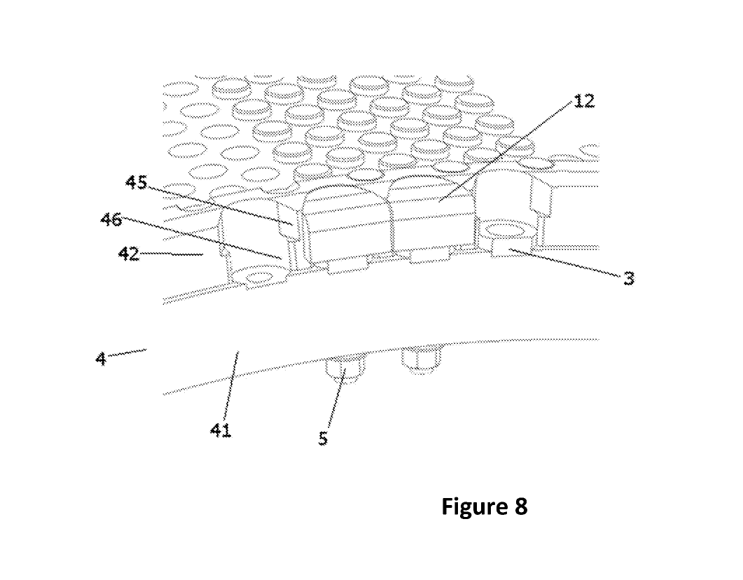

FIG. 8 shows a roller 4 with side wear protection elements 1 according to FIG. 7. The steel screen shielding 42 of the roller 4 comprises arc-shaped recesses 45 for the base body 11 of the side wear protection element 1 according to FIG. 7. This arc -shaped receptacle 45 surrounds the base body 13 (of the side wear protection element 1 according to FIG. 7) by more than 180° and therefore forms an axial fixing of the base body 13. Contact surfaces 46 for the hard body 12 are arranged above the recesses 45 and form a protection against torsion for the hard body 12 by their position. The side wear protection elements 1 with the threaded bolt 13 are also run through the roller edge 41 here and screwed with a screwed nut 5 and intermediate elements 3 are provided.

As set forth herein, embodiments of the present invention discussed herein have been described by way of example in this specification. Having thus described the basic concept of the invention, it will be rather apparent to those of ordinary skill in the art that the foregoing detailed disclosure is intended to be presented by way of example only, and is not limiting.

Various alterations, improvements, and modifications will occur and are intended to those skilled in the art, though not expressly stated herein. These alterations, improvements, and modifications are intended to be suggested hereby, and are within the spirit and the scope of the invention. Additionally, the recited order of processing elements or sequences, or the use of numbers, letters, or other designations therefore, is not intended to limit the claimed processes to any order, except as may be specified in the claims. Accordingly, the invention is limited only by the following claims and equivalents thereto.

What is claimed is:

1. A roller (4) of a roller press comprising a side wear protection element (1) with a base body (11) of an elastic material with a threaded bolt (13), wherein the threaded bold (13) of the side wear protection element (1) is run through a roller edge (41) of the roller (4).

2. The roller (4) of a roller press according to claim 1, wherein the base body (11) of the side wear protection element (1) has a parallelepipedic shape or is cylindrical with a round base surface which is preferably flattened on one side.

3. The roller (4) of a roller press according to claim 1, wherein the side of the base body (11) of the side wear protection element (1) directed toward the steel screen shielding (42) of the roller comprises at least one arch (43), preferably a concave arch and otherwise has a parallelepipedic shape.

4. The roller (4) of a roller press according to claim 1, wherein the hard bodies (2) are fastened on the sides of the base body (11) which form the jacket surface and the front side of the roller in the assembled state.

5. The roller (4) of a roller press according to claim 4, wherein an L-shaped hard body is fastened which extends from the jacket surface to the front side of the roller (4) and therefore covers the roller edge.

6. The roller (4) of a roller press according to claim 4, wherein the hard body or hard bodies (12) consist of hard metal or of a very firm iron alloy (IFW).

4. The roller (4) of a roller press according to claim 4, wherein the hard bodies (12) are soldered on.

8. The roller (4) of a roller press according to claim 1, wherein receptacles for tensioning pins (15) or tensioning pins (2) are arranged on the side of the base body (11) directed toward the roller edge (41).

9. The roller (4) of a roller press according to claim 1, wherein the threaded bolt (13) is stepped and has a distinctly greater diameter starting from the base body (11).

10. The roller (4) of a roller press according to claim 1, wherein the elastic material is an elastic, ductile steel.

11. The roller (4) of a roller press according to claim 1, wherein the support of the base body (11) on the roller is a linear support (14) in the axial direction of the roller.

12. The roller (4) for a roller press according to claim 1, wherein an intermediate element (3) that can be replaced with different thicknesses is arranged between the side wear protection element (1) and the roller edge (41).

13. The roller (4) for a roller press according to claim 1, wherein the threaded bolt (13) of the side wear protection element (1) is run through a roller edge (41) of the roller (4) and is screwed there, wherein the screwing has a pre-tension.

14. The roller (4) for a roller press according to claim 1, wherein the base body (1) is axially fixed in the steel screen shielding and can therefore receive transverse forces.

15. A roller press comprising a roller according to claim 1.
